(19) United States
(12) Patent Application Publication
(10) Pub. No.: US 2017/0151037 A1
(43) Pub. Date: Jun. 1, 2017

(54) ORTHODONTIC ARCHWIRE WITH VARIABLE CROSS SECTIONAL CONFIGURATION

(71) Applicant: Lingualign Corporation, Pohang-si, Gyeongsangbuk-do (KR)

(72) Inventor: Jong Ho Lee, Pohang-si, Gyeongsangbuk-do (KR)

(73) Assignee: Lingualign Corporation, Pohang-si, Gyeongsangbuk-do (KR)

(21) Appl. No.: 15/315,470

(22) PCT Filed: Jun. 25, 2015
(86) PCT No.: PCT/KR2015/006471

§ 371 Date: Dec. 1, 2016

(30) Foreign Application Priority Data
Jun. 12, 2015 (KR) 10-2015-0083497

(51) Int. Cl. A61C 7/20; A61C 7/14

(52) U.S. Cl. CPC A61C 7/20; A61C 7/145

(57) ABSTRACT

Disclosed is an orthodontic archwire with a varied cross-sectional structure. The archwire includes a rectangular cross section along every region, and a height and/or a width of the cross section between at least one ligating portion configured to be ligated to a slot of a bracket and the bracket is different from each other. The archwire includes an anterior region located at a center thereof, and a pair of posterior regions located at left and right sides of the anterior region. The anterior region includes at least one anterior wire protrusion protruding in a direction toward a patient's tongue from the ligating portion to be ligated to the slot of the bracket, and the posterior region has a constant cross section or has posterior wire protrusion protruding in the direction toward the patient's tongue from the ligating portion.

### CROSS-REFERENCE TO RELATED APPLICATIONS

This application is a national stage application of International Patent Application No. PCT/KR2015/006471 filed on Jun. 25, 2015, which claims priority to Korean Patent Application No. 10-2015-0083497 filed on Jun. 12, 2015, the entire contents of which are incorporated by reference herein.

### TECHNICAL FIELD

The present invention relates to an orthodontic archwire. More particularly, the present invention relates to a rectangular orthodontic archwire with a cross-sectional structure being varied along a region.

### BACKGROUND

In general, orthodontic therapy is to straighten crooked teeth by bonding brackets to the teeth and placing and ligating an archwire to slots of the brackets, wherein the teeth are corrected by retracting the teeth using a restoring force of the archwire or controlling torque of the archwire.

FIG. 1 shows an archwire 20 ligated to a slot 12 of a bracket 10.

An edgewise bracket with a constant in-out had been used in the past, but a pre-adjusted orthodontic bracket has been widely used in recent years in which compensation of first, second and third-order bends is imparted to an inside of the bracket.

Thus, a straight wire appliance (SWA) using a straight archwire is becoming more common in the orthodontic treatment, and orthodontic correction is more easily performed, in particular, in case of labial orthodontic treatment, as compared to the past.

In case of lingual orthodontics, however, since an interbracket distance is much shorter than that of the labial orthodontics, and a space is restricted, the treatment is still in trouble.

FIG. 2 shows the state in which correction brackets are bonded to tongue-facing surfaces of the teeth of a lower jaw, and the archwire is ligated to the brackets.

Since the lingual orthodontic treatment has the above limitations, it is preferable to utilize a setup model fabricated by cutting tooth portions from a malocclusion model of a patient and rearranging the tooth portions at proper position.

A technique of making a 3D setup model using computer software and determining shape or positions of brackets are now available.

Although the pre-adjusted bracket has a structure which is previously applied by the first, second and third-order bends, it is hard to find proper one suitable for situations of all individual teeth. Also, there is other problem in that a fine error occurring during correction is very complicated, and a finishing procedure is extended. Therefore, an orthodontic treatment using a customized bracket has been retracting.

In particular, some techniques are introduced which determine an angle of a base and wing, an orientation of a slot, and a location of a hook for a bracket every tooth to make the customized bracket.

One example of making the customized arch is disclosed in EP2736444, entitled “Orthodontic Archwires with Reduced Interference and Related Methods”, assigned to 3M Innovative Properties Co.

According to the disclosed patent, the wire bending can be automated by separating a wire into a plurality of segments, and then analyzing a radius of curvature for each segment, which can reduce interference between the customized archwire and a band portion of the associated bracket when placed on maloccluded dentition.

Meanwhile, a structure of an archwire is disclosed in US 20100304321, entitled “Five Segment Orthodontic Arch Wire And Orthodontic Apparatus Made Thereof′, of which the archwire is divided into five segments, rectangular cross-section of some segments being maintained intact, while other segments being rounded off, so that the segments have different cross-sectional structures.

The disclosed patent features that the rectangular archwires are rounded off for each region, and has advantages of allowing a canine tooth to slide with minimum possible frictional resistance and being able to be applied to various sizes of brackets.

According to the disclosed patents, the existing rectangular archwires are ligated to the customized brackets through a banding or post-processing process. It causes a problem in that a large error happens in the process of banding the archwire.

In addition, there is a limit to application of moment for torque control or tooth retraction depending on the bracket only. In the case where the archwire is tightly ligated to the slot of the bracket in order to prevent the tooth from slanting in a buccolingual direction at the lingual orthodontic treatment, resilience of the archwire gets weak, and a moving distance is shortened, thereby providing a sufficient incisor change.

### SUMMARY

Accordingly, the present invention has been made in view of the above-mentioned problems occurring in the related art, and an object of the present invention is to provide a rectangular orthodontic archwire with a cross-sectional structure being varied along a region, while keeping a rectangular cross-section.

In particular, another object of the present invention is to provide a rectangular orthodontic archwire with a variable cross-sectional structure, in which a height or a width of the archwire in the cross section or a protruding direction of a protrusion is set to be different from each other for each region according to positions of brackets determined by a setup model, thereby interference-fitting or fully engaging the archwire into the slot of the bracket for at least any tooth, and in which a thickness between the brackets is lowered to maintain high resilience.

To accomplish the above-mentioned object, according to one aspect of the present invention, there is provided an orthodontic archwire with a varied cross-sectional structure including: at least one region having a rectangular cross section; and at least one portion configured to be ligated to a slot of a bracket, wherein a height and/or a width of the cross section between the ligating portion and the bracket is different from each other.

In this instance the orthodontic archwire further includes an anterior region located at a center thereof, and a pair of posterior regions located at left and right sides of the anterior region.

The anterior region or the posterior region may be integrally formed with wire core protruding in a direction toward a patient's tongue or in a buccolingual direction.

The anterior region includes at least one anterior wire protrusion protruding in the direction toward the patient's tongue from the ligating portion to be ligated to the slot of the bracket, and the posterior region has a constant cross section, thereby meeting conformance as a retraction wire.

In particular, the anterior wire protrusion has a width and a height equal to dimensions of a slot of the bracket. Also, the anterior wire core has a height equal to that of the anterior wire protrusion, while the anterior wire core has a width shorter than that of the anterior wire protrusion, thereby preventing the anterior region from slanting in one direction and imparting sufficient moment by the resilience.

In addition, the posterior region has a width equal to that of the anterior wire protrusion, and the posterior region has a height shorter than that of the anterior wire core, thereby easily retracting the anterior region.

Meanwhile, there is provided a modified embodiment of the retraction wire of the size and the protruding direction of the anterior wire protrusion are changed.

In this instance, the anterior wire protrusion and the posterior region have the same width and height.

The height of the anterior wire core is set to be equal to that of the anterior wire protrusion, but the width anterior wire core is set to be shorter than that of the anterior wire protrusion.

The anterior wire protrusion may be formed to be slanted in an upward or downward direction to a lingual side.

In this instance, the size, in particular, the height, of the anterior wire protrusion is set to be smaller than dimensions of the slot of the bracket, thereby easily ligating the wire to the slot and obtaining the interference fit.

The anterior region and the posterior region are provided with the protrusions of the same size as that of the slot of the bracket, respectively, and the size of all regions between the brackets is set to be smaller than that of the protrusions, thereby ensuring the conformance as a finishing wire.

To this end, the anterior region is provided with the anterior wire protrusions protruding in the direction toward the patient's tongue from every ligating portion to be ligated to the slots of the brackets, and anterior wire cores are formed between the anterior wire protrusions and have a size smaller than that of the anterior wire protrusion.

The posterior region is provided with the posterior wire protrusions protruding in the direction toward the patient's tongue from every ligating portion to be ligated to the slots of the brackets, and posterior wire cores are formed between the posterior wire protrusions and have a size smaller than that of the posterior wire protrusion.

In this instance, the anterior wire core has the size equal to or smaller than that of the posterior wire core.

With the above configuration of the present invention, the height or width of the archwire in the cross section or the protruding direction of the protrusion is set to be different from each other for each region according to positions of the brackets, thereby interference-fitting the archwire into the slot of the bracket for at least any tooth. Also, the thickness between the brackets is lowered to maintain high resilience.

In particular, in order to prevent anterior teeth from slanting in the buccolingual direction, the anterior wire protrusions are interference-fitted into the slots of the brackets, respectively. Since the size between the anterior brackets is lowered, thereby imparting a sufficient moment to the teeth by the resilience. In addition, in the case of the posterior region, all regions have the size slightly smaller than that of the slots of the bracket, thereby easily retracting the anterior region toward the posterior region.

The archwire configured as described above can be used as a retraction wire for retracting teeth in early stages of lingual orthodontic treatment.

The anterior wire protrusions and the posterior wire protrusion are set to have the same size as that of the slots of the brackets, the anterior wire protrusion and the posterior wire protrusion are interference-fitted into the slots of the brackets, respectively, and the archwire between the brackets has the size smaller than the protrusions, thereby imparting a sufficient moment to the teeth and thus easily adjusting the teeth slanted in the buccolingual direction.

The archwire configured as described above can be used as a finishing wire used in advanced stages of lingual orthodontic treatment.

The orthodontic archwire with the varied cross-sectional structure according to the present invention can be used together with a customized archwire for lingual orthodontic treatment. In particular, the present invention can be usefully utilized for lingual orthodontic treatment of restricted space.

### BRIEF DESCRIPTION OF THE DRAWINGS

FIG. 1 is an enlarged perspective view illustrating a rectangular archwire which is ligated to a slot of a bracket according to the related art.

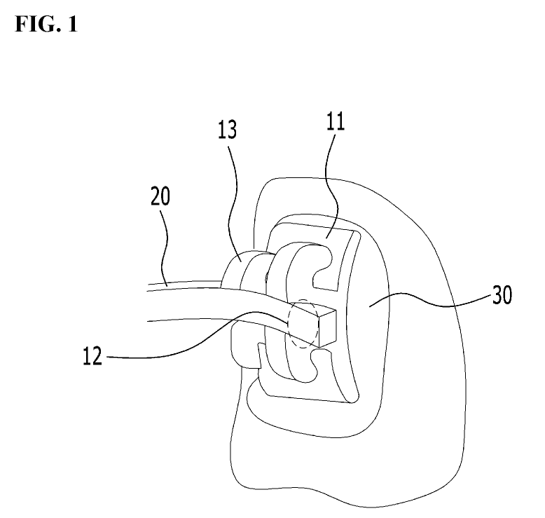

FIG. 2 is a perspective view illustrating a ligating relationship between an archwire and brackets for lingual orthodontic treatment according to the related art.

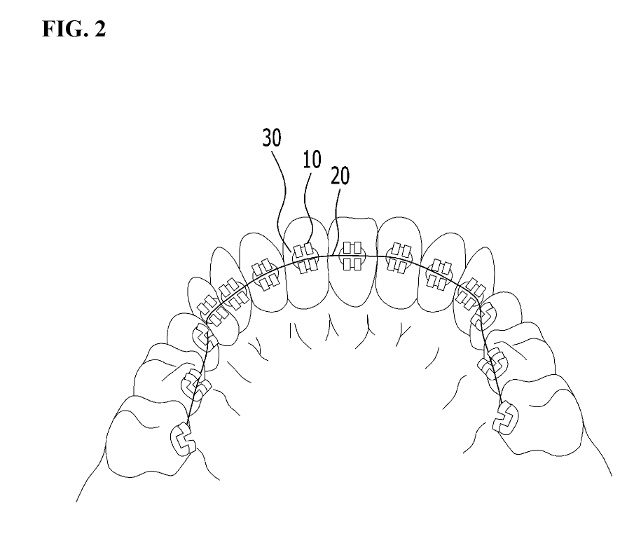

FIG. 3 is a perspective view illustrating a structure of a rectangular archwire according to one embodiment of the present invention.

FIGS. 4A and 4B are views illustrating a cross-sectional structure of the rectangular archwire in FIG. 3 which is ligated to a slot of a lingual-side bracket.

FIG. 5 a perspective view illustrating a structure of a rectangular archwire according to one modified embodiment of the present invention.

FIGS. 6A and 6B are views illustrating a cross-sectional structure of the rectangular archwire in FIG. 5 which is ligated to a slot of a lingual-side bracket.

FIG. 7 a perspective view illustrating a structure of a rectangular archwire according to another embodiment of the present invention.

FIGS. 8A and 8B are views illustrating a cross-sectional structure of the rectangular archwire in FIG. 7 which is ligated to a slot of a lingual-side bracket.

FIGS. 9A, 9B and 9C are views illustrating a protrusion according to a modified embodiment.

### DETAILED DESCRIPTION OF THE DISCLOSURE

Hereinafter, preferred embodiments of the present invention will now be described in detail with reference to the attached drawings.

An orthodontic archwire with a varied cross-sectional structure according to the present invention has a different cross section along a region, contrary to an orthodontic archwire according to the related art.

Preferably, the orthodontic archwire has a rectangular wire of a rectangular cross-sectional structure along every region, but a cross-sectional area, or a height or width of the archwire may be varied depending upon an anterior region and a posterior region. Alternatively, a cross-sectional area or a width or height of a ligating portion of the archwire to be ligated to a slot of a bracket may be varied.

Since a location of the ligating portion to be ligated to the slot of the bracket should be determined in advance, the present invention can be applied to a customized archwire for lingual orthodontic treatment. The present invention is preferably ligated to a customized bracket.

An orthodontic wire according to the related art is fabricated by a drawing or extrusion method. Since the orthodontic archwire with the varied cross-sectional structure according to the present invention has the different cross section along a region, the archwire cannot be fabricated by the drawing or extrusion method, but can be fabricated by machining using CNC, electric discharge machining or laser machining, except for the extrusion.

Therefore, a material or a fabricating process should be considered.

A titanium molybdenum alloy among materials for the orthodontic wires according to the related art is suitable for other materials, but has a drawback in that frictional resistance is high when retracting the teeth.

Preferably, Ti6Al4V-ELI which is a kind of titanium alloys can be used. Ti6Al4V-ELI is not used as a material for the orthodontic wire. However, it is proved that the material is suitable for the orthodontic archwire with the varied cross-sectional structure according to the present invention, because of the easy machining and the high compatibility with a human body.

Ti6Al4V-ELI has stiffness of about 0.56, which corresponds to a middle level between Nitinol of 0.17 and stainless steel of 1.

In the configuration of the orthodontic archwire with the varied cross-sectional structure according to the present invention, the anterior region and the posterior region may be provided with protrusions.

In the case where the protrusion protrudes in the direction toward the patient's tongue, the orthodontic archwire of the present invention can be used as a wire for lingual orthodontic treatment. In the case where the protrusion protrudes in the buccolingual direction, the orthodontic archwire of the present invention can be used as a wire for buccal orthodontic treatment.

### Embodiment 1

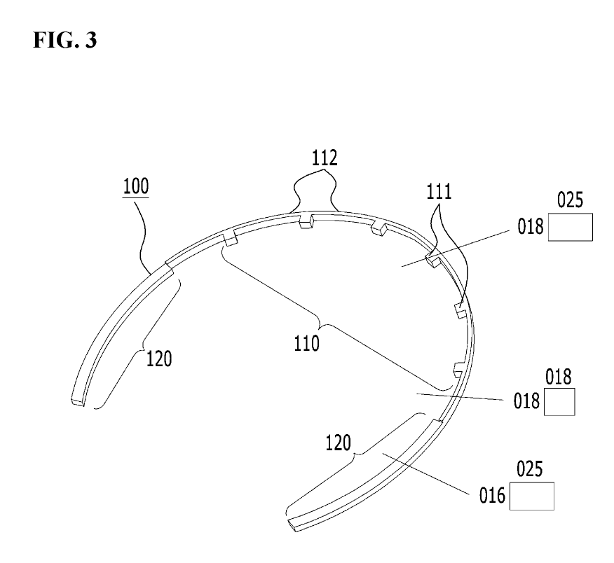

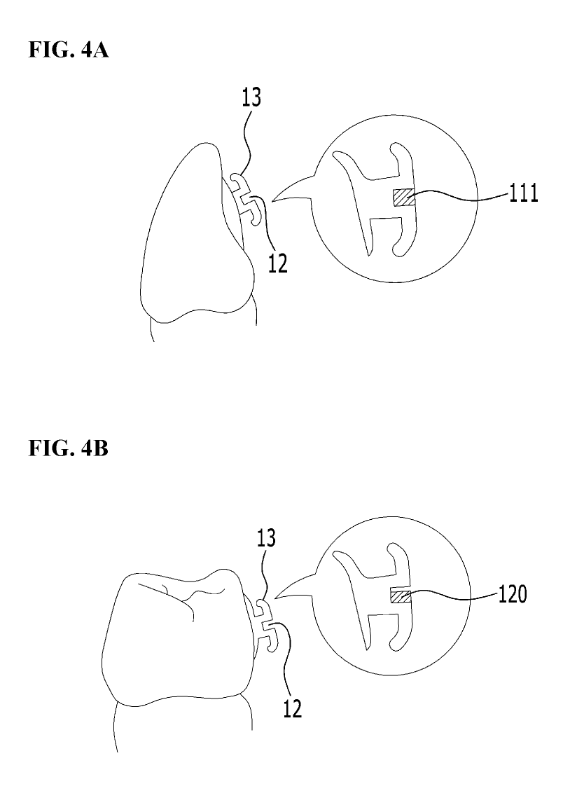

FIG. 3 is a perspective view illustrating a structure of a rectangular archwire according to one embodiment of the present invention. FIGS. 4A and 4B are views illustrating a cross-sectional structure of the rectangular archwire in FIG. 3 which is ligated to a slot of a lingual-side bracket.

The embodiment of the present invention illustrated in FIGS. 3, 4A and 4B relates to a customized archwire for lingual orthodontic treatment to show a retraction wire for retracting teeth in early stages of lingual orthodontic treatment.

As illustrated in FIG. 3, an orthodontic archwire 100 according to the embodiment consists of an anterior region 110 and posterior regions 120, the anterior region 110 having a plurality of anterior wire protrusions 111 protruding in a direction toward a patient's tongue (lingual side).

The anterior region 110 and the posterior region 120 have different cross sections, and the anterior region 110 has anterior wire protrusions 111 and anterior wire cores 112, with cross sections of the anterior wire protrusions 111 and cross sections of the anterior wire cores 112 being different from each other.

The anterior region 110 is located at a center of the orthodontic archwire 100 according to the embodiment. Preferably, after a location of the anterior region of an upper or lower jaw of a patient is determined by use of a setup model which is fabricated by cutting tooth portions from a malocclusion model of a patient and rearranging the tooth portions at ideal positions, the region corresponding to the location can be set as the anterior region 110.

A pair of posterior regions 120 are disposed at left and right ends of the anterior region 110, and correspond to posterior regions of the upper or lower jaw of the patient.

As illustrated in FIG. 3, the anterior region 110 includes the anterior wire protrusions 111 protruding in the direction toward the patient's tongue, and a position of each anterior wire protrusion 111 corresponds to a ligating portion of the archwire to be ligated to a slot of a bracket.

Since each anterior region of the upper and lower jaws consists of a pair of central incisions, a pair of lateral incisions, and a pair of canine teeth, the anterior region 110 includes six anterior wire protrusions 111.

The locations of the anterior wire protrusions 111 are respectively determined according to a location of a bracket for the anterior region after the bracket for the anterior region of the patient is determined by use of a setup model.

Preferably, the anterior region 110 and the posterior regions 120 have a constant cross section.

The orthodontic archwire 100 according to the embodiment includes a structure capable of maximizing conformance with a retraction wire for retracting the teeth. To this end, a height of the anterior wire protrusions 111 is set to be equal to that of the anterior wire core 112, and a width of the anterior wire protrusion 111 is set to be equal to that of slots 12 of a bracket 10.

That is, the anterior wire protrusions 111 are interference-fitted or fully engaged into the slots 12 of the bracket 10, as illustrated in FIG. 4A.

A height of the anterior wire core 112 is set to be narrower than that of the anterior wire protrusion 111.

With the above design, for the lingual orthodontic treatment which is limited to a relatively short interbracket distance, high resilience is maintained in the anterior region 110, thereby achieving the effective tooth retraction. In addition, since the anterior wire protrusions 111 are interference-fitted into the slots 12 of the bracket, it is possible to prevent the anterior region from slanting in one direction.

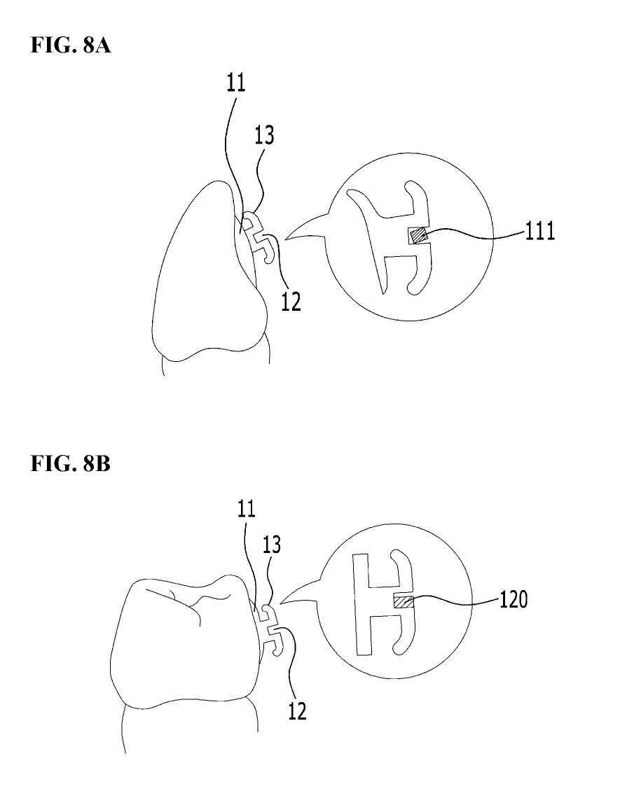

Preferably, the posterior region 120 is provided with no separate protrusion (see reference numeral 121 in FIG. 8) protruding in the direction toward the patient's tongue, and has a constant rectangular cross section along every region.

The width of the posterior region 120 is set to be equal to that of the anterior wire protrusion 111, and the height thereof is set to be narrower than that of the anterior wire core 112.

As illustrated in FIG. 4B, it can be recognized that there is a clearance between the archwire and the slot of the posterior bracket when the archwire is ligated to the slot.

Therefore, the archwire can be easily slid and ligated to the slot 12 of the posterior bracket, and a frictional resistance can be reduced when the tooth is retracted.

As illustrated in FIG. 3 showing one example of the retraction wire, the anterior wire protrusion 111 may be set to have 0.025 inch in width and 0.018 inch in height, and the anterior wire core 112 may be set to have 0.018 inch in width and 0.018 inch in height.

The posterior region 120 may be set to have 0.025 inch in width and 0.016 in height.

The above dimensions are derived as optimum values in case where a size of the bracket is 018 by 025, but can be changed appropriately depending upon the size of the bracket.

### Embodiment 2

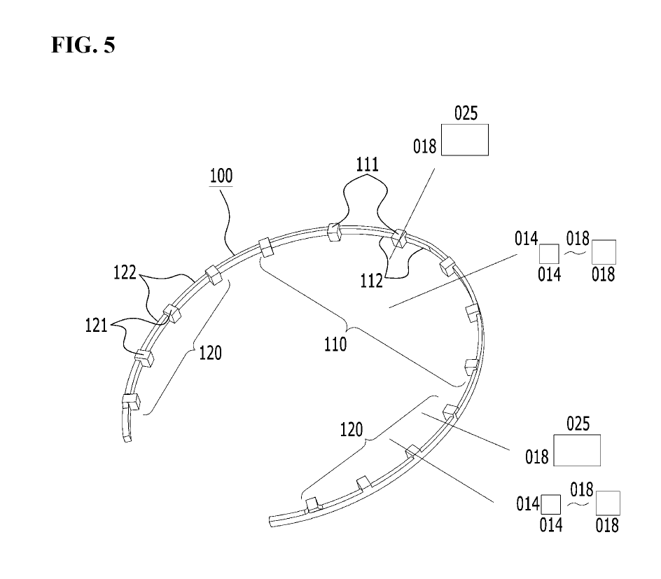

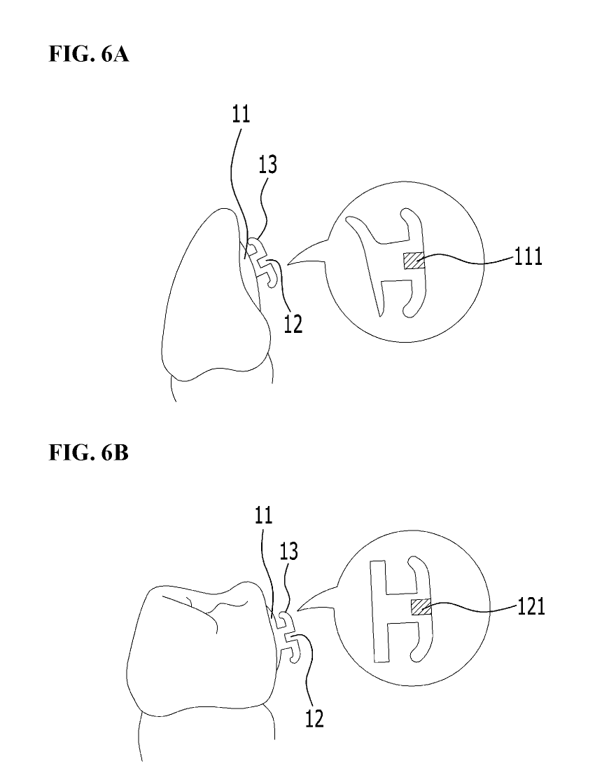

FIG. 5 a perspective view illustrating a structure of a rectangular archwire according to one modified embodiment of the present invention. FIGS. 6A and 6B are views illustrating a cross-sectional structure of the rectangular archwire in FIG. 5 which is ligated to a slot of a lingual-side bracket.

The embodiment of the present invention illustrated in FIGS. 5, 6A and 6B relates to a structure of a retraction wire, of which a size of anterior wire protrusions 111 is smaller than that of the slot 12 of the bracket.

Contrary to the orthodontic archwire illustrated in FIG. 3, the orthodontic archwire illustrated in FIG. 5 features that an anterior region 110 and posterior region 120 have the same height.

Only widths of the anterior wire protrusions 111, the anterior wire cores 112 and the posterior region 120 are different from each other along the region.

More specifically, according to this embodiment illustrated in FIG. 5, the anterior wire protrusions 111 have the height equal to that of the anterior wire cores 112, but the width longer than that of the anterior wire cores 112.

In this embodiment, however, the dimensions of the anterior wire protrusions 111 are slightly smaller than those of the slots 12.

Preferably, the cross section of the posterior region 120 has the same width and height as those of the anterior wire protrusions 111, but a slope is different from each other.

The anterior wire protrusions 111 protrude from positions of the anterior region 110 which correspond to anterior brackets of the patient. The anterior wire protrusions 111 are not formed in a direction perpendicular to the anterior wire cores 112, but are formed to be slightly slanted in one direction.

In other words, it can be recognized that the embodiment illustrated in FIG. 3 features that the anterior wire protrusions 111 are perpendicular to the anterior wire cores 112 when seen from all sides, for example, a front or lateral side, but the modified embodiment illustrated in FIG. 5 features that the anterior wire protrusions 111 are slanted in a downward direction when seen from a lateral side.

More specifically, the anterior wire protrusions 111 are formed in such a way that the protrusions protrude in the direction toward the patient's tongue, and then are slightly slanted in the downward direction.

With the above design, when the archwire is not tightly ligated to the slot 12 of the bracket bonded to the lingual side of the patient's tooth, as illustrated in FIG. 6, but is ligated to the slot 12 in an oblique posture in such a way that at least two of four corners of the anterior wire protrusion 111 are brought into contact with the inner surface of the slot 12 and thus are supported by the inner surface.

Although the anterior wire protrusion 111 is configured to be slightly smaller than the size of the slot 12 of the bracket, the protruding shape of the anterior wire protrusion 111 is slanted in one direction, thereby achieving the effect of the interference fit after the anterior wire protrusion 111 is ligated to the slot 12.

In addition, since the anterior wire protrusion 111 has the size smaller than that of the slot 12 of the bracket, the ligating work can be easily carried out, and the archwire can cope with various sizes of the brackets.

As illustrated in FIG. 5 showing another example of the retraction wire, the anterior wire protrusion 111 may be set to have 0.025 inch in width and 0.016 inch in height, and the anterior wire core 112 may be set to have 0.022 inch in width and 0.016 inch in height.

The posterior region 120 may be set to have 0.025 inch in width and 0.016 in height.

In other words, the height of the retraction wire is not varied along the region, but the width is varied along the section.

The above dimensions are derived as optimum values in case where a size of the bracket is 018 by 025, but can be changed appropriately depending upon the size of the bracket.

### Embodiment 3

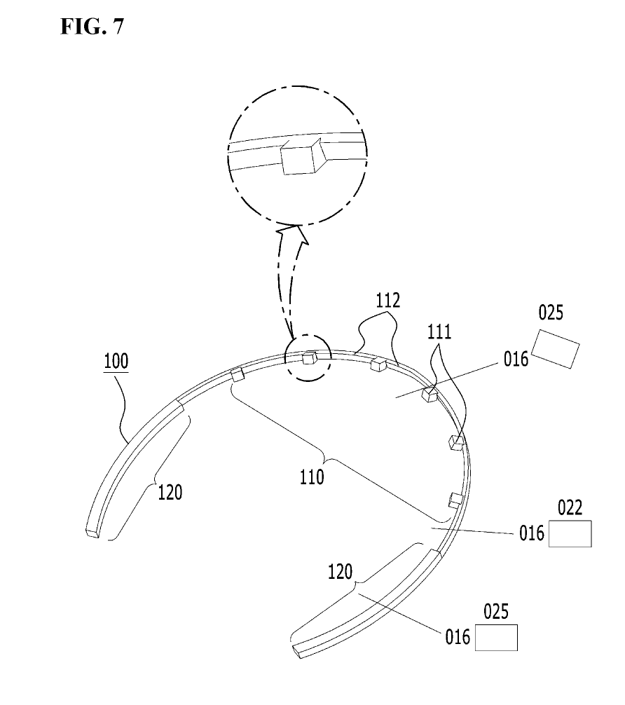

FIG. 7 a perspective view illustrating a structure of a rectangular archwire according to another embodiment of the present invention. FIGS. 8A and 8B are views illustrating a cross-sectional structure of the rectangular archwire in FIG. 7 which is ligated to a slot of a lingual-side bracket.

The embodiment of the present invention illustrated in FIGS. 7, 8A and 8B relates to a customized archwire for lingual orthodontic treatment to correspond to a structure of a finishing wire used in advanced stages of lingual orthodontic treatment.

Contrary to the first embodiment, protrusions 111 and 121 protrude from an anterior region 110 and a pair of posterior region 120 in a direction toward a patient's tongue.

The anterior region 110 includes at least one anterior wire protrusion 111 protruding in the direction toward the patient's tongue from a location corresponding to a slot 20 of a bracket, and an anterior wire core 112 connecting the anterior wire protrusions 111.

The anterior wire protrusions 111 are respectively provided at positions corresponding to the slots 12 of the brackets which are bonded to the lingual side of the anterior region of the upper or lower jaw of the patient, and have the same dimensions as those of the slots 12 of the brackets.

That is, the anterior wire protrusions 111 are set to have the same width and height as those of the slots 12 of the brackets.

The posterior region 120 includes at least one posterior wire protrusion 121 protruding in the direction toward the patient's tongue from a location corresponding to the slot of the bracket, and a posterior wire core 122 connecting the posterior wire protrusions 121.

The posterior wire protrusions 121 are respectively provided at positions corresponding to the slots 12 of the brackets 10 which are bonded to the lingual side of the anterior region of the upper or lower jaw of the patient, and have the same dimensions as those of the slots 12 of the brackets.

In order to achieve the conformance as the finishing wire, the anterior wire core 112 is set to have a width shorter than that of the anterior wire protrusion 111.

Preferably, the anterior wire core 112 is set to have a height shorter than that of the anterior wire protrusion 111. The anterior wire core 112 can be set to have the height equal to the largest height of the anterior wire protrusion 111, but should not be set to be longer than the largest height.

The posterior wire core 122 is set to have a width shorter than that of the posterior wire protrusion 121.

Preferably, the posterior wire core 122 is set to have a height shorter than that of the posterior wire protrusion 121. The posterior wire core 122 can be set to have the height equal to the largest height of the posterior wire protrusion 121, but should not be set to be longer than the largest height.

As illustrated in FIG. 7, the anterior wire core 112 and the posterior wire core 122 may be formed to have a rectangular shape in a cross section.

For example, the height of the anterior wire core 112 and the posterior wire core 122 may be set in the range of 0.014 inch to 0.018 inch, and the width of the anterior wire core 112 and the posterior wire core 122 may be set in the range of 0.014 inch to 0.018 inch. For example, the anterior wire core 112 and the posterior wire core 122 may be set to have 0.014 inch in width and 0.016 inch in height, respectively.

In this instance, in order to achieve the conformance as the finishing wire, a cross-sectional area of the anterior wire core 112 should be smaller than or equal to that of the posterior wire core 122.

As illustrated in FIG. 8, the anterior wire protrusion 111 and the posterior wire protrusion 121 are interference-fitted into the slots 12 of the brackets 10, respectively, and the region between the brackets can impart a sufficient moment to the teeth by the resilience of the anterior wire core 112 and the posterior wire core 122 which are relatively thin, thereby easily adjusting the teeth slanted in a buccolingual direction.

As illustrated in FIG. 8, the anterior wire protrusion 111 and the posterior wire protrusion 121 is set to have 0.025 inch in width, and the anterior wire protrusion 111 and the posterior wire protrusion 121 is set to have 0.018 inch in height, so that the protrusions are interference-fitted into the slots of the brackets.

Meanwhile, the anterior wire core 112 and the posterior wire core 122 may be set to have any value within 0.014 inch to 0018 inch in width and height, respectively.

The above dimensions are derived as optimum values in case where a size of the bracket is 018 by 025, but can be changed appropriately depending upon the size of the bracket.

Although FIGS. 3, 4A, 4B, 5, 6A, 6B, 7, 8A and 8B show that the protrusions 111 and 121 have a hexahedral shape for convenience, the shape is not limited to the hexahedron if the cross section thereof corresponds to that of the slot of the bracket so as to be interference-fitted into the slot.

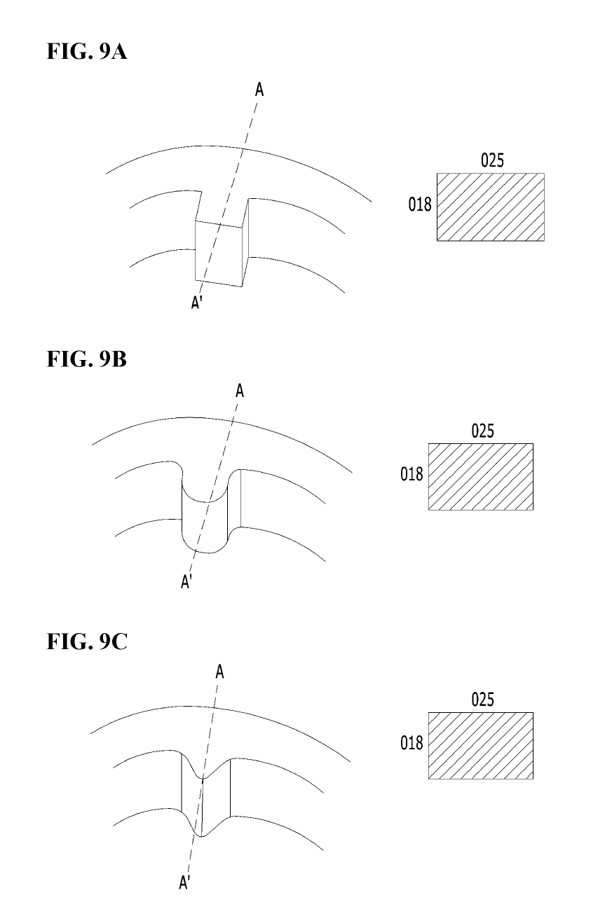

FIGS. 9A, 9B and 9C are views illustrating a protrusion according to a modified embodiment.

FIG. 9A shows a case wherein the anterior wire protrusion 111 and the posterior wire protrusion 121 have the hexagonal structure, as illustrated in FIGS. 3, 4A, 4B, 5, 6A and 6B.

For the purpose of the easy ligating work, the anterior wire protrusion 111 and the posterior wire protrusion 121 may be formed in the shape of a half-column or a trigonal prism, as illustrated in FIGS. 9B and 9C.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

The present invention can be applied to the field of orthodontic treatment.

Although the embodiment suitable for the lingual orthodontic treatment has been explained herein, the present invention is not limited to the archwire for lingual orthodontic treatment, but can be applied to an archwire for buccal orthodontic treatment.

1. An orthodontic archwire with a varied cross-sectional structure comprising:
at least one region having a rectangular cross section; and
at least one portion configured to be ligated to a slot of a bracket,
wherein a height and/or a width of the cross section between the ligating portion and the bracket is different from each other.

2. The orthodontic archwire according to claim 1, further comprising an anterior region (110) located at a center thereof, and a pair of posterior regions (120) located at left and right sides of the anterior region (110),
wherein the anterior region (110) includes at least one anterior wire protrusion (111) protruding in a direction toward a patient's tongue from the ligating portion to be ligated to the slot of the bracket, and
the posterior region (120) has a constant cross section.

3. The orthodontic archwire according to claim 2, wherein the anterior wire protrusion (111) has a width and a height equal to dimensions of a slot (12) of the bracket, and
the anterior wire core (112) has a height equal to that of the anterior wire protrusion (111), while the anterior wire core (112) has a width shorter than that of the anterior wire protrusion (111).

4. The orthodontic archwire according to claim 3, wherein the posterior region (120) has a width equal to that of the anterior wire protrusion (111), and
the posterior region (120) has a height shorter than that of the anterior wire core (112).

5. The orthodontic archwire according to claim 2, wherein the anterior wire protrusion (111) is formed to be slanted in an upward or downward direction to a lingual side, and
the anterior wire protrusion (111) has a height shorter than dimensions of the slot (12) of the bracket.

6. The orthodontic archwire according to claim 5, wherein the width and the height of the anterior wire protrusion (111) are equal to those of the posterior region (120), and
the height of the anterior wire core (112) is equal to that of the anterior wire protrusion (111), and the width of the anterior wire core (112) is shorter than that of the anterior wire protrusion (111).

7. The orthodontic archwire according to claim 1, further comprising an anterior region (110) located at a center thereof, and a pair of posterior regions (120) located at left and right sides of the anterior region (110),
wherein the anterior region (110) includes at least one anterior wire protrusion (111) protruding in a direction toward a patient's tongue from the ligating portion to be ligated to the slot of the bracket, and an anterior wire core (112) for connecting the anterior wire protrusions (111), and
each of the pair of the posterior regions (120) includes at least one posterior wire protrusion (121) protruding in the direction toward the patient's tongue from the ligating portion, and a posterior wire core (122) for connecting the posterior wire protrusions (121).

8. The orthodontic archwire according to claim 7, wherein the anterior wire protrusion (111) and the posterior wire protrusion (121) have a width and a height equal to dimensions of a slot (12) of the bracket,
the anterior wire core (112) has a width shorter than that of the anterior wire protrusion (111), while the anterior wire core (112) has a height equal to or shorter than that of the anterior wire protrusion (111), and
the posterior wire core (122) has a width shorter than that of the posterior wire protrusion (121), and the posterior wire core (122) has a height equal to or shorter than that of the posterior wire protrusion (121).

9. The orthodontic archwire according to claim 8, wherein the posterior wire core (122) has a cross-sectional area equal to or smaller than that of the anterior wire core (112).

10. The orthodontic archwire according to claim 8, wherein the anterior wire core (112) and the posterior wire core (122) have a rectangular cross section, respectively.

11. The orthodontic archwire according to claim 2, wherein the anterior wire protrusion (111) and the posterior wire protrusion (121) are formed in a shape of a hexahedron, a half-column or a trigonal prism.

12. The orthodontic archwire according to claim 1, wherein the archwire is made from Ti6Al4V-ELI material.

13. The orthodontic archwire according to claim 7, wherein the anterior wire protrusion (111) and the posterior wire protrusion (121) are formed in a shape of a hexahedron, a half-column or a trigonal prism.
